(19) United States
(12) Patent Application Publication
(10) Pub. No.: US 2013/0291977 A1
(43) Pub. Date: Nov. 7, 2013

(54) FAUCET OUTLET STRUCTURE WITH A WATER CURTAIN

(71) Applicant: Yung-Wen Chung, Changhua (TW)

(72) Inventor: Yung-Wen Chung, Changhua (TW)

(73) Assignee: ZEVA CORP., CHANGHUA (TW)

(21) Appl. No.: 13/664,130

(22) Filed: Oct. 30, 2012

(30) Foreign Application Priority Data
May 4, 2012 (TW) 101208471

(51) Int. Cl. F15B 13/00

(52) U.S. Cl. 137/801

(57) ABSTRACT

A faucet outlet structure with a close and hollow water curtain is disclosed. The structure has a faucet body having a water outlet tube extending forward at an upper portion of the faucet body, a water outlet formed at a front portion of the water outlet tube, and a water stopping portion disposed inside the water outlet. When the water from the faucet flows down through the water stopping portion, a close and hollow water curtain is generated, so that the water can flow through a larger area to increase the washing efficiency and to further achieve the goal of saving water.

### FIELD OF THE INVENTION

The present invention relates to a faucet outlet structure with a close and hollow water curtain, and more particularly to water flowing down from the faucet through the water stopping portion inside the water outlet to generate a close and hollow water curtain, so that the water can flow through a larger area to increase the washing efficiency and to further achieve the goal of saving water.

### BACKGROUND OF THE INVENTION

Conventionally, the faucet installed on the sink generates a cylindrical water flow with a smaller washing area and can only focus on a partial area. Therefore, it may be inefficient because the user has to repeatedly change the position of both hands to completely wash both hands and items. A faucet structure that can generate a larger washing area has been developed, wherein a water outlet tube is formed at an upper portion of a main body and a U-shaped water outlet is formed at a rear end of the water outlet tube, so when the water flows down the U-shaped water outlet, a half-opened water curtain is formed to achieve the goal of saving water by increasing the washing areas. Even though the washing area is larger, the water curtain is still half-opened, so the user cannot wash the hands conveniently. In other words, the user still has to move the hands while washing them, which lacks of washing efficiency. Therefore, there remains a need for a new and improved faucet to generate a close and hollow water curtain, so that the water can flow through a larger area to increase the washing efficiency and to further achieve the goal of saving water.

### SUMMARY OF THE INVENTION

The problem the present invention wants to solve is that the water curtain is still half-opened, so the user cannot wash the hands conveniently. In other words, the user still has to move the hands while washing them, which lacks of washing efficiency.

To present invention provides a faucet outlet structure with a close and hollow water curtain. The structure has a faucet body having a water outlet tube extending forward at an upper portion of the faucet body, a water outlet formed at a front portion of the water outlet tube, and a water stopping portion disposed inside the water outlet. When the water from the faucet flows down through the water stopping portion, a close and hollow water curtain is generated, so that the water can flow through a larger area to increase the washing efficiency and to further achieve the goal of saving water.

Comparing with the conventional arts, the present invention is advantageous because when the water from the faucet flows down through the water stopping portion inside the water outlet, a close and hollow water curtain is generated, so that the water can flow through a larger area to increase the washing efficiency and to further achieve the goal of saving water.

### BRIEF DESCRIPTION OF THE DRAWINGS

FIG. 1 illustrates a three-dimensional view of the first embodiment in the present invention.

FIG. 2 illustrates a partial sectional view of the first embodiment in the present invention.

FIG. 3 illustrates a two-dimensional view of the circular narrow gap in the present invention.

FIG. 4 illustrates a three-dimensional view of the second embodiment in the present invention.

FIG. 5 illustrates a partial sectional view of the second embodiment in the present invention.

FIG. 6 illustrates a three-dimensional view of the third embodiment in the present invention.

FIG. 7 illustrates a three-dimensional exploded view of the third embodiment in the present invention.

FIG. 8 illustrates a partial sectional view of the third embodiment in the present invention.

FIG. 9 illustrates a three-dimensional view of the fourth embodiment in the present invention.

FIG. 10 illustrates a partial sectional view of the fourth embodiment in the present invention.

FIG. 11 illustrates a three-dimensional view of the fifth embodiment in the present invention.

FIG. 12 illustrates a partial sectional view of the fifth embodiment in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

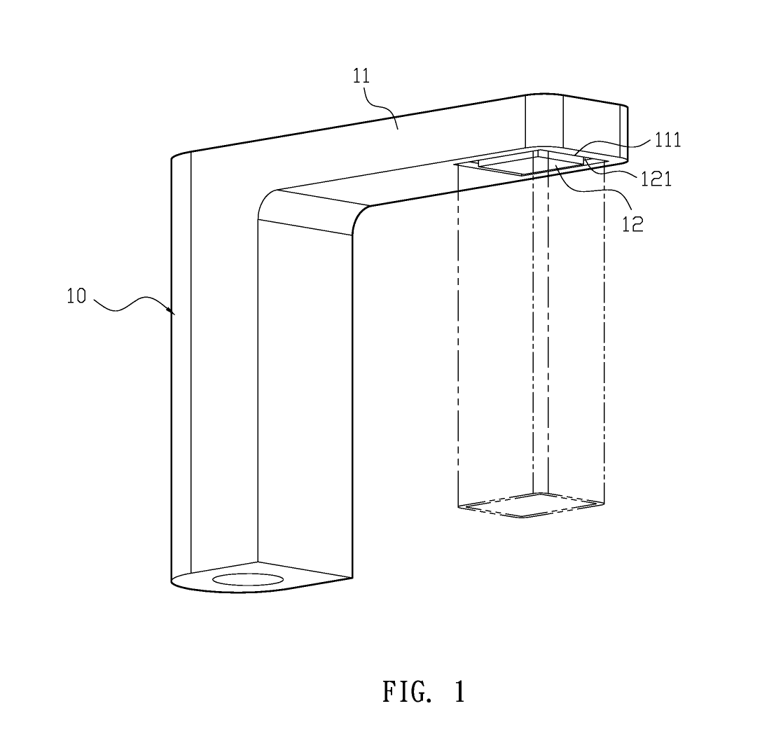

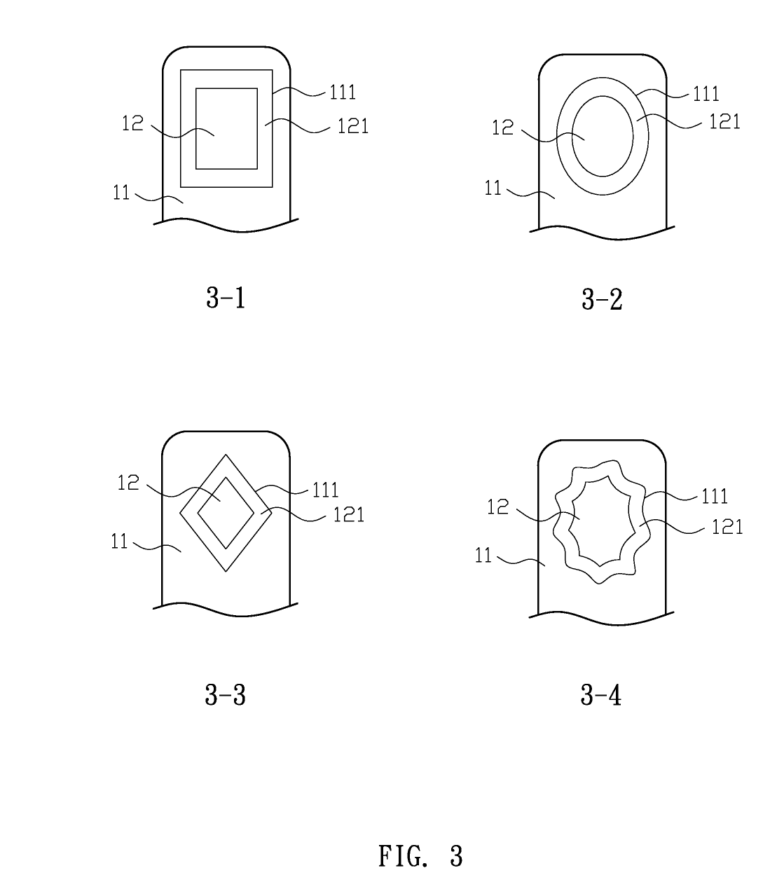

Referring to FIGS. 1, 2 and 3 for the first embodiment in the present invention, a faucet outlet structure with a water curtain includes a faucet body (10) having a water outlet tube (11) extending forward at an upper portion of the faucet body (10), and a water outlet (111) is formed at a front portion of the water outlet tube (11). The water outlet (111) can be square, round, triangle, diamond-shaped, oval-shaped or any shape with a closed and hollow feature. A water stopping portion (12) can be formed at an upper portion of the water outlet (111), which can be extended downward to the edge of the opening of the water outlet (111). The periphery of the water stopping portion (12) is spaced with the edge of the opening of the water outlet (111), and the shape of the periphery of the water stopping portion (12) can be of the same shape of the edge of the opening of the water outlet (111), so that there is a corresponding circular narrow gap (121) therebetween, which can be square, round, triangle, diamond-shaped, oval-shaped or any shape with a closed and hollow feature. Furthermore, when the water flows from the water outlet (111) and goes down through the circular narrow gap (121), a closed and hollow water curtain is generated.

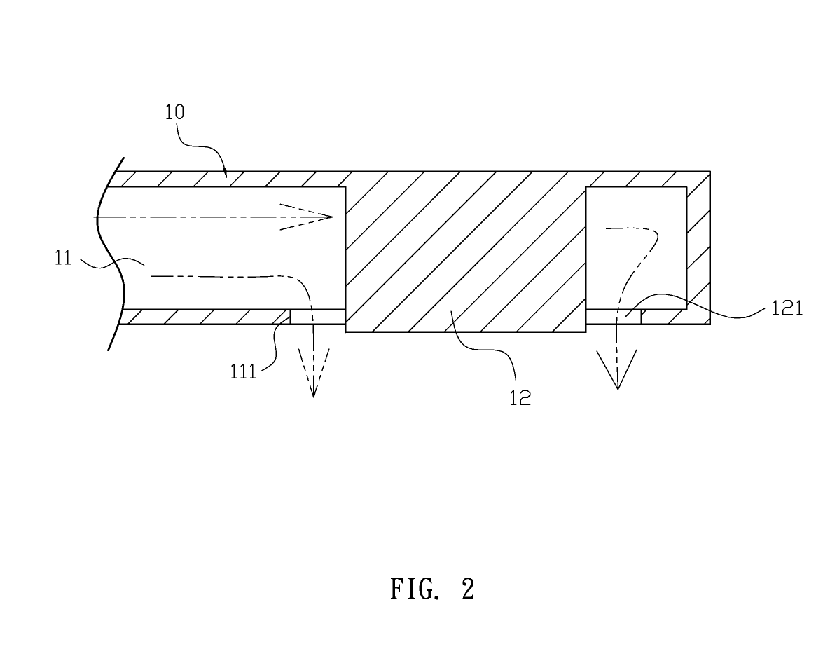

Referring to FIGS. 1 and 2 for the use of the present invention, when the faucet body (10) is connected to a water source to output the water from the water outlet tube (11), and the water stopping portion (12) is formed inside the water outlet (111) of the faucet body (10) and spaced with the edge of the opening of the water outlet (111), the circular narrow gap (121) is formed and when the water flows from the water outlet (111) and goes down through the circular narrow gap (121), a closed and hollow water curtain is generated. Under these circumstances, the water can flow through a larger area to increase the washing efficiency and to further achieve the goal of saving water.

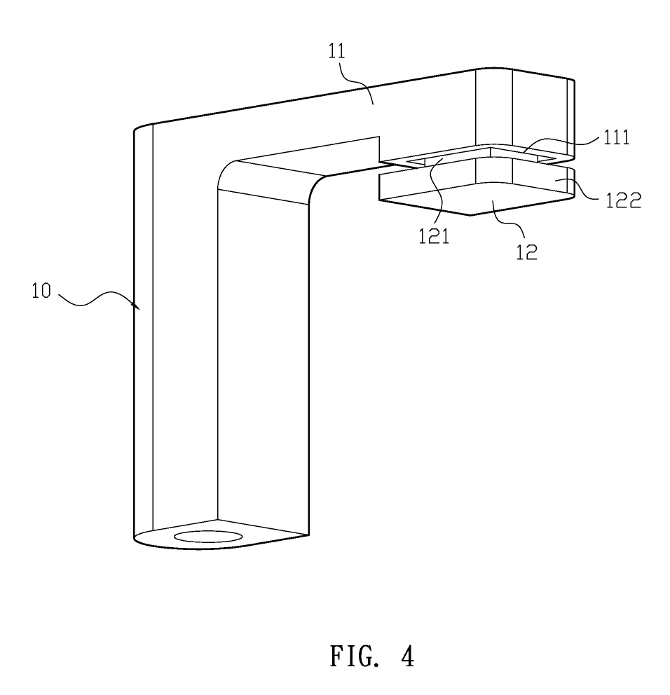

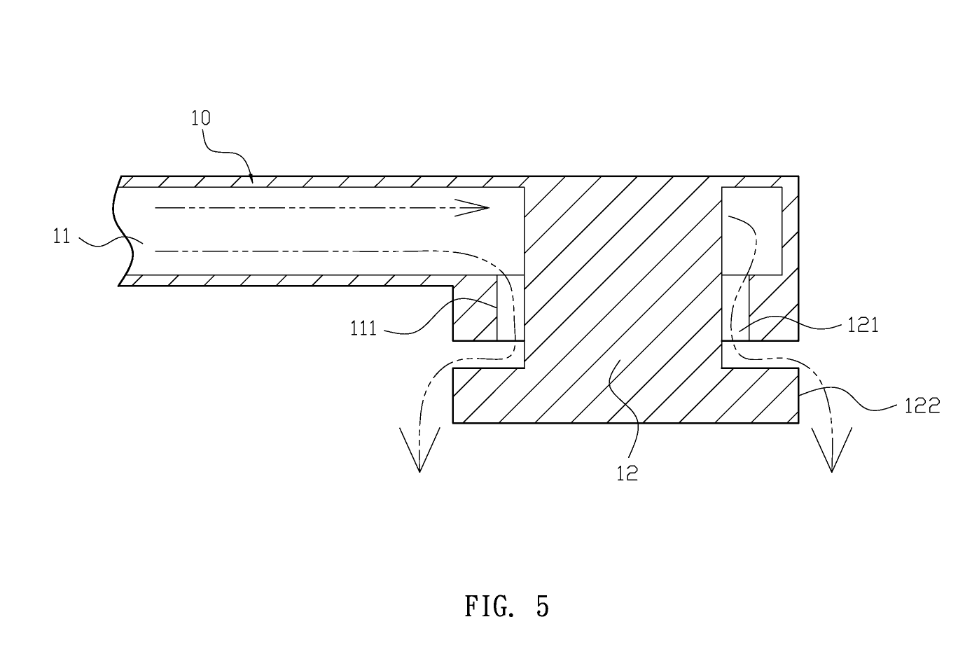

Referring to FIGS. 4 and 5 for the second embodiment, the water stopping portion (12) extends downward to protrude out the water outlet (111), and a circular protruding edge (122) is formed at the periphery of the protruding portion of the water outlet (111), so that the water flow of the water outlet (111) can flow out along the circular protruding edge (122) to expand the area of the water flow to further increase the washing efficiency of the faucet.

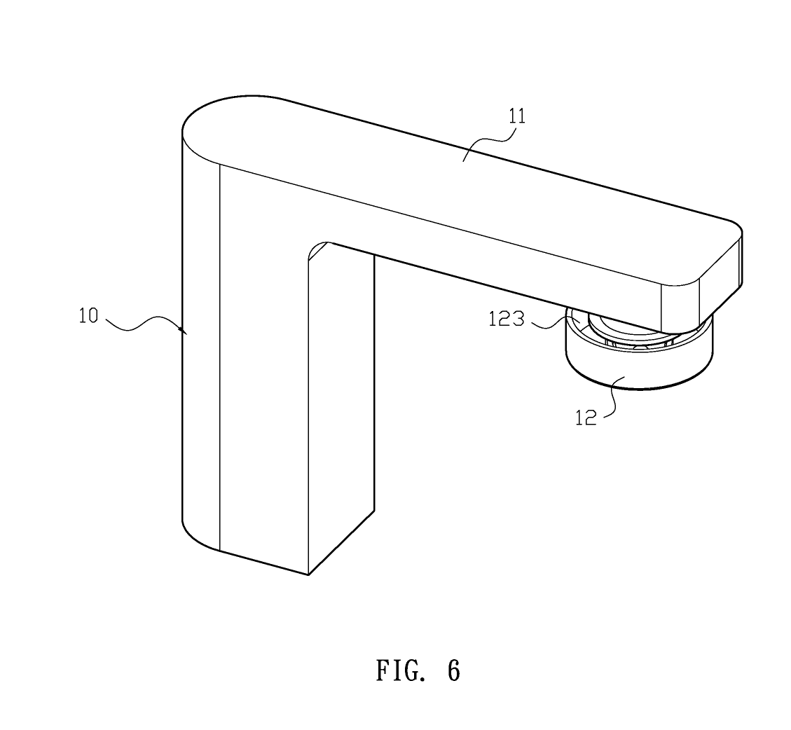

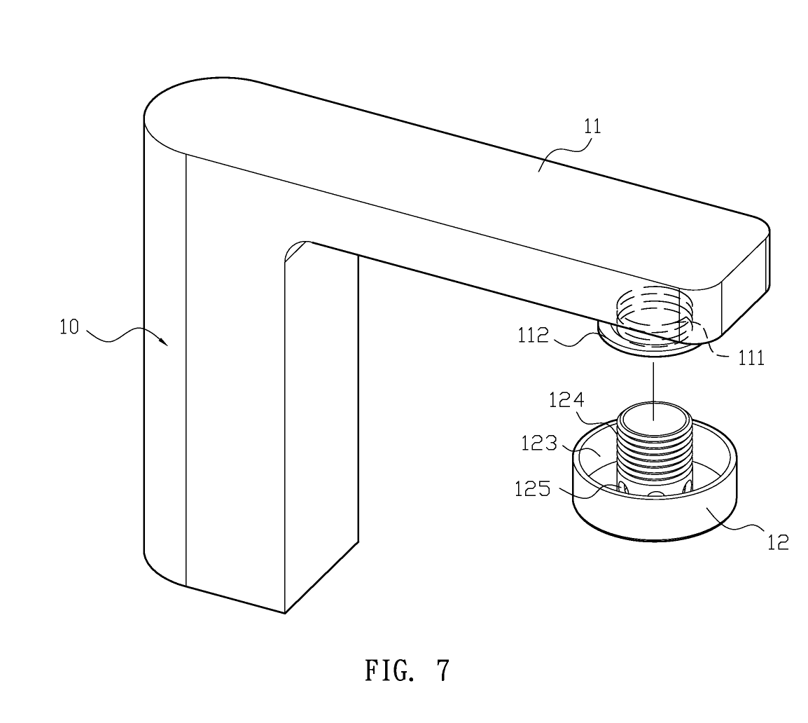

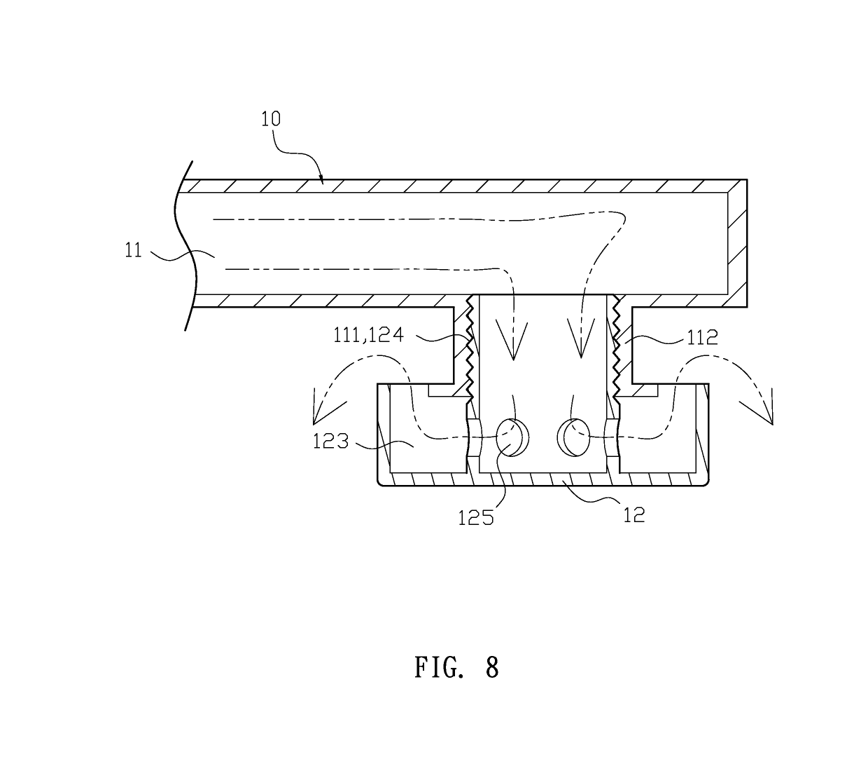

Referring to FIGS. 6 to 8 for the third embodiment, the water outlet tube (11) of the faucet body (10) and the water stopping portion (12) can be formed as one piece (as shown in FIGS. 1 to 5), or assembled after individually manufactured. The water flow of the water outlet (111) of the water outlet tube (11) extends downward and a connecting portion (112) is formed thereon. The water stopping portion (12) has a water collecting chamber (123) having an opening upward, and a connecting tube (124) is formed at a surface of the water collecting chamber (123) to connect to the connecting portion (112) of the water outlet tube (11). The connecting tube (124) has at least one through hole (125) at nearly the bottom portion thereof to connect to the water collecting chamber (123), so that the area of the water flow can be expanded as well to achieve the goal of increasing the washing area.

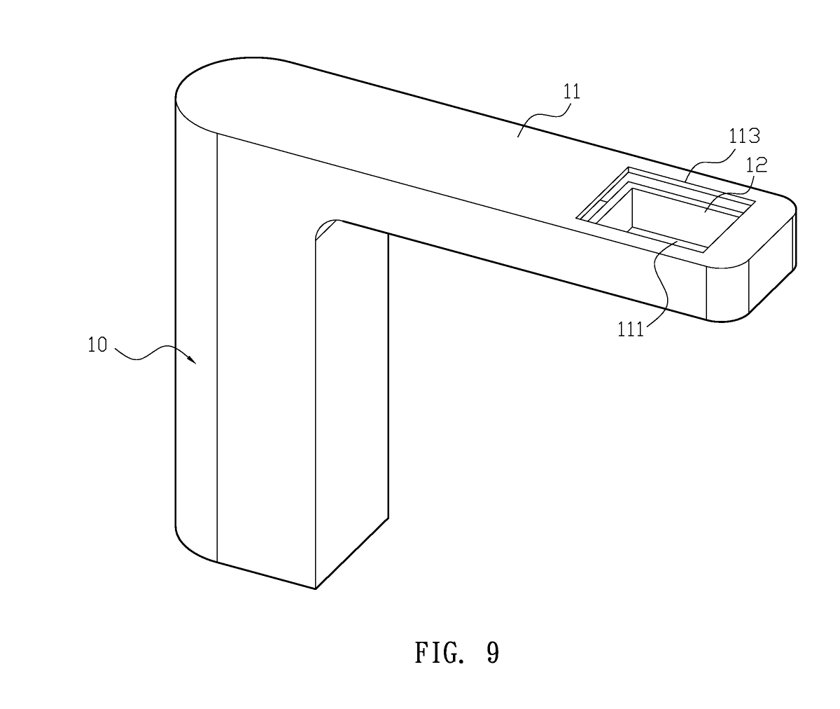

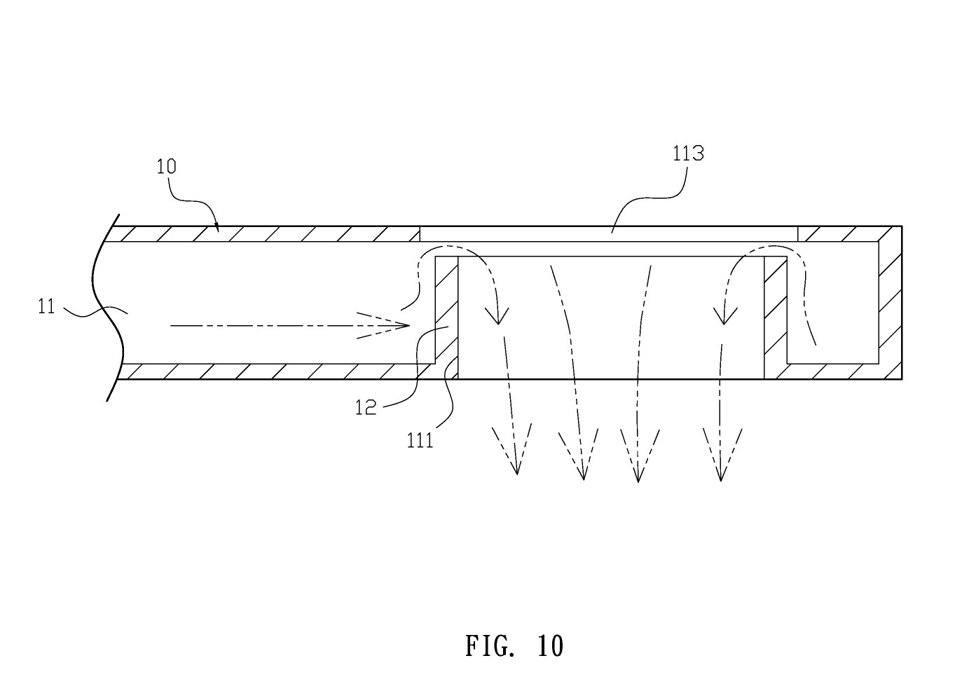

Referring to FIGS. 9 and 10 for the fourth embodiment, a hollow hole (113) is formed at an upper portion of the water outlet (111) of the water outlet tube (11), and the edge of the water outlet (111) can extend upward to form the water stopping portion (12). When the water level is higher than the water stopping portion (12), the water can flow down through the inner portion of the water stopping portion (12) to output water as a water curtain.

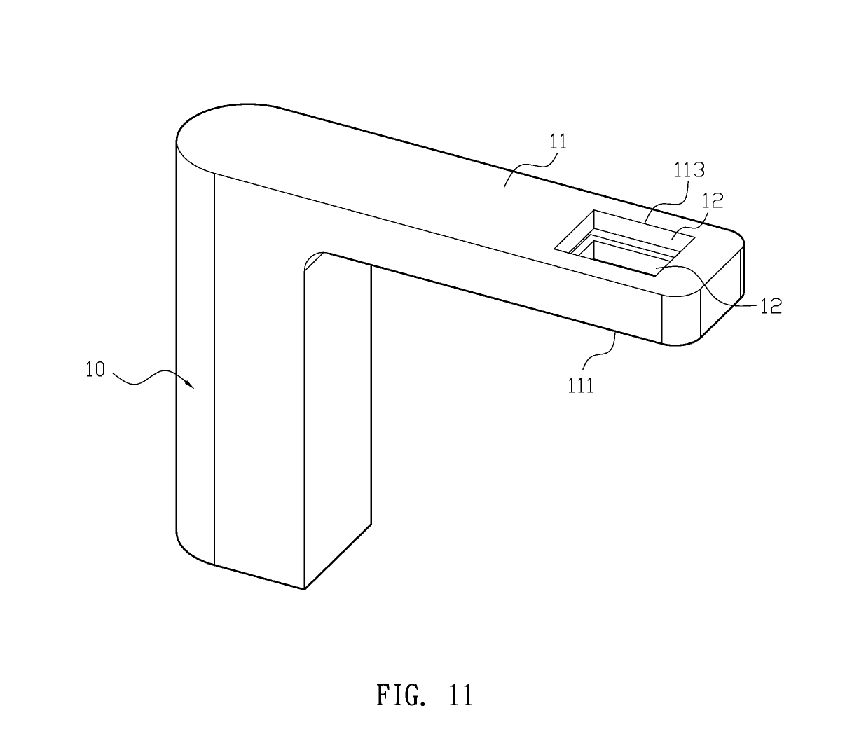

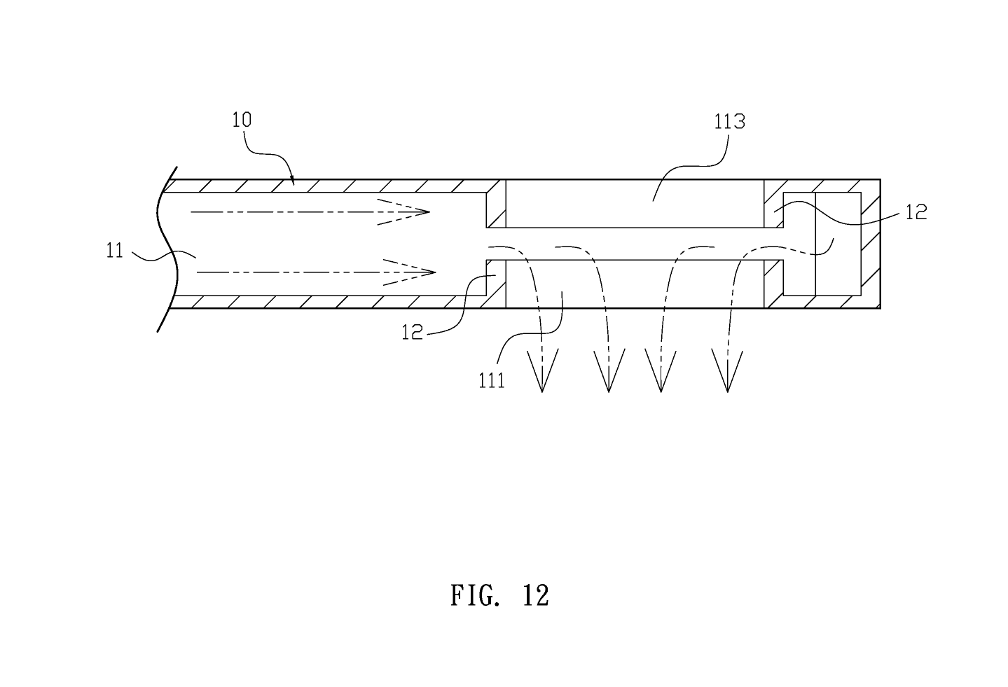

Referring to FIGS. 11 and 12 for the fifth embodiment, the edge of the water outlet (111) and the hollow hole (113) each extends to form a water stopping portion (12), and two water stopping portions (12) are spaced. When the water level is higher than the water stopping portion (12) of the water outlet (111), the water can flow down through the inner portion of the water stopping portion (12) to output water as a water curtain.

According to the embodiments stated above, the present invention is advantageous because when the water from the faucet flows down through the water stopping portion (12) inside the water outlet (111), a close and hollow water curtain is generated, so that the water can flow through a larger area to increase the washing efficiency and to further achieve the goal of saving water.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A faucet outlet structure with a close and hollow water curtain comprising a faucet body having a water outlet tube extending forward at an upper portion of the faucet body, a water outlet formed at a front portion of the water outlet tube, and a water stopping portion disposed inside the water outlet, wherein the water from the faucet flows down through the periphery of the water stopping portion to generate a close and hollow water curtain.

2. The faucet outlet structure with a close and hollow water curtain of claim 1, wherein the water stopping portion extends downward to the edge of the water outlet spaced with the periphery of the water stopping portion, so that a circular narrow gap is formed between the edge of the water outlet and the periphery of the water stopping portion.

3. The faucet outlet structure with a close and hollow water curtain of claim 2, wherein the shape of the periphery of the water stopping portion matches the shape of the edge of the water outlet.

4. The faucet outlet structure with a close and hollow water curtain of claim 2, wherein the water stopping portion extends downward and protrudes out the water outlet, and a circular protruding edge is formed at the periphery of a protruding portion of the water outlet.

5. The faucet outlet structure with a close and hollow water curtain of claim 1, wherein the edge of the water outlet of the water outlet tube extends downward and a connecting portion is formed thereon, and the water stopping portion has a water collecting chamber having an opening upward, and a connecting tube is formed at a surface of the water collecting chamber to connect to the connecting portion of the water outlet tube, and the connecting tube has at least one through hole at nearly the bottom portion thereof to connect to the water collecting chamber.

6. The faucet outlet structure with a close and hollow water curtain of claim 1, wherein a hollow hole is formed at an upper portion of the water outlet of the water outlet tube.

7. The faucet outlet structure with a close and hollow water curtain of claim 1, wherein the edge of the water outlet extends upward to form the water stopping portion.

8. The faucet outlet structure with a close and hollow water curtain of claim 6, wherein the edge of the water outlet extends upward to form the water stopping portion.

9. The faucet outlet structure with a close and hollow water curtain of claim 6, wherein the edge of the water outlet and the hollow hole each extends to form a water stopping portion, and two water stopping portions are spaced.
